(19) United States
(12) Patent Application Publication
(10) Pub. No.: US 2025/0253462 A1
(43) Pub. Date: Aug. 7, 2025

(54) POWER STORAGE DEVICE AND VEHICLE

(71) Applicant: TOYOTA JIDOSHA KABUSHIKI KAISHA, Toyota-shi (JP)

(72) Inventor: Yutaroh GOTOH, Toyota-shi (JP)

(73) Assignee: TOYOTA JIDOSHA KABUSHIKI KAISHA, Toyota-shi (JP)

(21) Appl. No.: 18/976,892

(22) Filed: Dec. 11, 2024

(30) Foreign Application Priority Data
Feb. 1, 2024 (JP) 2024-014053

(51) Int. Cl. H01M 50/238; H01M 50/249; H01M 50/262

(52) U.S. Cl. CPC H01M 50/238; H01M 50/249; H01M 50/262; H01M 2220/20

(57) ABSTRACT

A power storage device includes: a first power storage module; a second power storage module disposed above the first power storage module; an accommodation case that accommodates the first power storage module and the second power storage module; and a support member disposed between the first power storage module and the second power storage module in an up-down direction, wherein a lower side of the second power storage module is fixed to an upper surface side of the support member, an upper side of the first power storage module is fixed to a lower surface side of the support member, and the support member is fixed to the accommodation case.

### CROSS REFERENCE TO RELATED APPLICATIONS

This nonprovisional application is based on Japanese Patent Application No. 2024-014053 filed on Feb. 1, 2024 with the Japan Patent Office, the entire contents of which are hereby incorporated by reference.

### BACKGROUND

### Field

The present disclosure relates to a power storage device and a vehicle.

### Description of the Background Art

As a conventional power storage device, Japanese Patent Laying-Open No. 2020-061380 discloses a configuration in which battery modules (power storage modules) are disposed in each of an upper case, an intermediate case and a lower case, and these cases are stacked in multiple stages in an up-down direction.

### SUMMARY

However, in the configuration disclosed in Japanese Patent Laying-Open No. 2020-061380, the plurality of cases are manufactured, the power storage modules are placed in each of the cases, and the cases are fastened to each other, which requires labor and cost in manufacturing. In order to eliminate such complications, it is conceivable to stack the plurality of power storage modules in multiple stages in the up-down direction and accommodate the plurality of power storage modules in one accommodation case. However, this requires the large-sized accommodation case. Therefore, when no measures are taken, there are concerns that the accommodation case is likely to be deformed.

The present disclosure has been made in view of the above-described problem and an object of the present disclosure is to provide a power storage device in which the rigidity of an accommodation case that accommodates a plurality of power storage modules disposed in an up-down direction can be increased, and a vehicle including the power storage device.

A power storage device according to the present disclosure includes: a first power storage module; a second power storage module disposed above the first power storage module; an accommodation case that accommodates the first power storage module and the second power storage module; and a support member disposed between the first power storage module and the second power storage module in an up-down direction. A lower side of the second power storage module is fixed to an upper surface side of the support member. An upper side of the first power storage module is fixed to a lower surface side of the support member. The support member is fixed to the accommodation case.

According to the above-described configuration, the support member to which the first power storage module and the second power storage module disposed in the up-down direction are fixed is fixed to the accommodation case, whereby the rigidity of the accommodation case can be increased.

In the power storage device according to the present disclosure, the support member may include a fixed portion fixed to the accommodation case. The accommodation case may include an upper case. In this case, the fixed portion may be fixed to the upper case.

According to the above-described configuration, the fixed portion is fixed to the upper case, whereby the rigidity of the upper case can be increased.

In the power storage device according to the present disclosure, in a front-rear direction orthogonal to the up-down direction, the upper case may include a first wall portion facing the second power storage module from a front side, and a second wall portion facing the second power storage module from a rear side. The support member may be fixed to each of the first wall portion and the second wall portion.

According to the above-described configuration, the support member is fixed to the first wall portion and the second wall portion of the upper case at two locations on the front side and on the rear side, and thus, the rigidity of the upper case can be further increased.

In the power storage device according to the present disclosure, each of the first power storage module and the second power storage module may include a front end portion and a rear end portion in a front-rear direction orthogonal to the up-down direction. The rear end portion of the second power storage module may be located on a front side relative to the rear end portion of the first power storage module.

According to the above-described configuration, an inclination extending inward toward the upward direction may be formed on a rear wall portion of the upper case that faces the rear end portion of the first power storage module and the rear end portion of the second power storage module, due to a draft angle or the like when molding the upper case. In such a case, by fixing the second power storage module to the support member such that the rear end portion of the second power storage module is located on the front side relative to the rear end portion of the first power storage module, a smaller gap between the rear wall portion of the upper case and a lowermost power storage stack of a plurality of power storage stacks that constitute the first power storage module can be achieved. Thus, a dead space in the accommodation case can be reduced and the plurality of power storage stacks can be disposed in the accommodation case at high density.

A vehicle according to the present disclosure includes: the above-described power storage device; a vehicle frame member; and a coupling member that couples the accommodation case and the vehicle frame member to each other. The coupling member is fixed to a portion where the support member is fixed to the accommodation case.

According to the above-described configuration, the portion where the support member to which the first power storage module and the second power storage module disposed in the up-down direction are fixed is fixed to the accommodation case is coupled to the vehicle frame member, whereby the rigidity of the accommodation case and the rigidity of the vehicle frame member can be increased.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic view of a vehicle according to a first embodiment.

FIG. 2 is a schematic view of a power storage device according to the first embodiment.

FIG. 3 is a perspective view of a support member according to the first embodiment.

FIG. 4 is a cross-sectional view showing a state in which the support member is fixed to an accommodation case, according to the first embodiment.

FIG. 5 is a plan view showing a state in which the power storage device is fixed to a frame member of the vehicle, according to the first embodiment.

FIG. 6 is an enlarged perspective view showing a state in which the power storage device is fixed to the frame member by a coupling member, according to the first embodiment.

FIG. 7 is a cross-sectional view showing a state in which a support member is fixed to an accommodation case, according to a second embodiment.

FIG. 8 is a schematic view of a power storage device according to a third embodiment.

### DESCRIPTION OF THE PREFERRED EMBODIMENTS

Hereinafter, embodiments of the present disclosure will be described in detail with reference to the drawings. In the embodiments described below, the same or common components are denoted by the same reference characters in the drawings and description thereof will not be repeated.

### First Embodiment

FIG. 1 is a schematic view of a vehicle according to a first embodiment. A vehicle 1 according to the first embodiment will be described with reference to FIG. 1.

Vehicle 1 according to the first embodiment is a hybrid vehicle that can travel using motive power of at least one of a motor and an engine, or an electrically powered vehicle that travels using driving force obtained by electrical energy.

As shown in FIG. 1, vehicle 1 includes a front seat 2, a rear seat 3, a floor panel 4, and a power storage device 10. Power storage device 10 is configured by electrically connecting a plurality of power storage modules described below in series. Thus, power storage device 10 can supply electric power to an electric motor at high power. The whole of power storage device 10 may be disposed below floor panel 4.

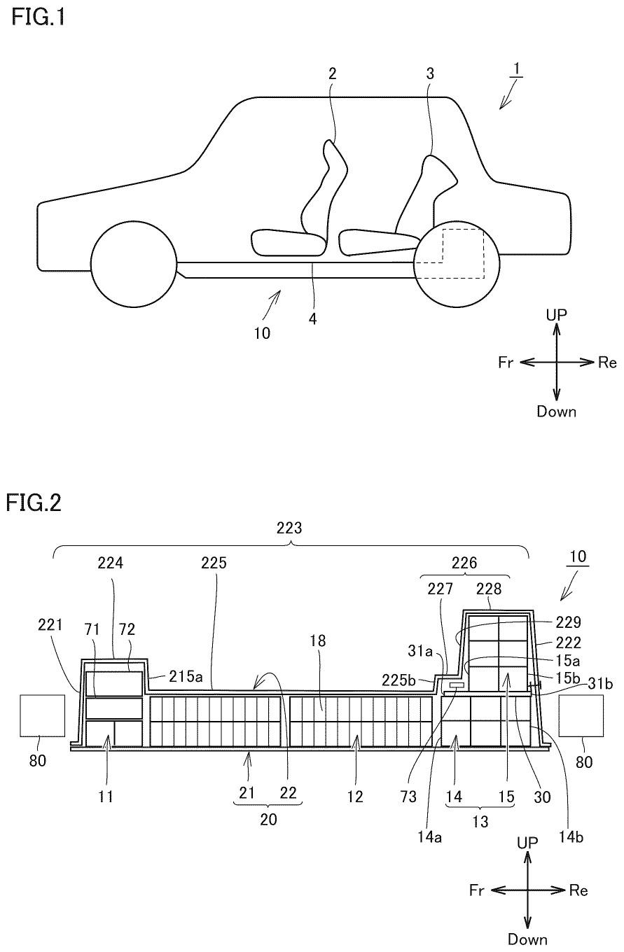

FIG. 2 is a schematic view of the power storage device according to the first embodiment. Details of power storage device 10 will be described with reference to FIG. 2.

Power storage device 10 is disposed between electric drive mechanisms 80 spaced apart from each other in a front-rear direction of vehicle 1. Each of electric drive mechanisms 80 is, for example, eAxle that can directly supply electric power to an axle of a vehicle.

Power storage device 10 includes a plurality of power storage modules, an accommodation case 20, a support member 30, and a plurality of electronic devices 71, 72 and 73. Each of electronic devices 71, 72 and 73 is, for example, a control device such as a junction box, a battery ECU or a battery management system (BMS).

The plurality of power storage modules include a front-side module 11, a center-side module 12 and a rear-side module 13. Front-side module 11, center-side module 12 and rear-side module 13 are disposed in this order from the front side to the rear side of the vehicle.

Front-side module 11 is configured, for example, by arranging, side by side in the front-rear direction, power storage stacks extending in a width direction of the vehicle. Electronic devices 71 and 72 are disposed above front-side module 11.

Center-side module 12 is located between front-side module 11 and rear-side module 13. Center-side module 12 is configured by stacking, in an up-down direction, power storage stacks extending in the front-rear direction, and arranging the stacked power storage stacks side by side in the front-rear direction. More particularly, two power storage stacks are arranged side by side in the front-rear direction, and another power storage stack is stacked on top of each of these power storage stacks.

Rear-side module 13 includes a first power storage module 14 and a second power storage module 15. First power storage module 14 and second power storage module 15 are arranged side by side in the up-down direction. Each of first power storage module 14 and second power storage module 15 is configured by disposing, in a matrix shape, power storage stacks extending in the width direction of vehicle 1.

Each of the above-described power storage stacks included in front-side module 11, center-side module 12 and rear-side module 13 is configured by arranging a plurality of power storage cells 18 in a predetermined direction. Each of power storage cells 18 is, for example, a secondary battery such as a nickel-metal hydride battery or a lithium ion battery. Each of power storage cells 18 may have a rectangular shape. Each of power storage cells 18 may be a power storage cell including a liquid electrolyte, or may be a power storage cell including a solid electrolyte. Alternatively, each of power storage cells 18 may be a chargeable and dischargeable capacitor.

Second power storage module 15 is disposed above first power storage module 14. A height of second power storage module 15 is higher than that of first power storage module 14, for example. A length of second power storage module 15 in the front-rear direction is shorter than that of first power storage module 14.

First power storage module 14 has a front end portion 14a and a rear end portion 14b in the front-rear direction. Second power storage module 15 has a front end portion 15a and a rear end portion 15b in the front-rear direction.

Rear end portion 15b of second power storage module 15 is located on the front side relative to rear end portion 14b of first power storage module 14. Front end portion 15a of second power storage module 15 is located on the rear side relative to front end portion 14a of first power storage module 14. Electronic device 73 is disposed on the lower front side of second power storage module 15.

Accommodation case 20 accommodates the plurality of power storage modules (front-side module 11, center-side module 12 and rear-side module 13), support member 30 and the plurality of electronic devices 71, 72 and 73.

Accommodation case 20 includes a lower case 21 and an upper case 22. Lower case 21 has a plate shape, for example. It should be noted that the shape of lower case 21 is not limited to the plate shape and may be a substantially box shape opened upward. In this case, a flange portion may be provided at an upper end of lower case 21. Lower case 21 is made of, for example, a metal material such as SUS.

Upper case 22 is provided to cover lower case 21. Upper case 22 has a substantially box shape opened downward. A flange portion is provided at a lower end of upper case 22 and the flange portion is fixed to a perimeter edge portion of lower case 21. When lower case 21 includes the flange portion as described above, the flange portion of upper case 22 and the flange portion of lower case 21 may be fastened to each other by a fastening member.

From the viewpoint of weight reduction, upper case 22 may be made of a resin material. Upper case 22 may be made of a metal material such as aluminum or SUS. A rigidity of upper case 22 may be lower than that of lower case 21.

Upper case 22 has a front wall portion 221, a rear wall portion 222 and a top wall portion 223. Front wall portion 221 is located on the front side of front-side module 11. Front wall portion 221 may be inclined rearward toward the upward direction, due to a draft angle or the like when molding upper case 22.

Rear wall portion 222 is located on the rear side of rear-side module 13. Rear wall portion 222 functions as a second wall portion facing second power storage module 15 from the rear side. More particularly, rear wall portion 222 faces first power storage module 14 and second power storage module 15 from the rear side.

Rear wall portion 222 may be inclined frontward toward the upward direction, due to a draft angle or the like when molding upper case 22. In this case, by fixing the second power storage module to support member 30 such that rear end portion 15b of second power storage module 15 is located on the front side relative to rear end portion 14b of first power storage module 14, a smaller gap between rear wall portion 222 and the lowermost power storage stack of the plurality of power storage stacks that constitute first power storage module 14 can be achieved. As a result, a dead space in accommodation case 20 can be reduced and the plurality of power storage stacks can be disposed in the accommodation case at high density. Particularly, when power storage device 10 is disposed between two electric drive mechanisms 80 as described above, a placement space is limited, and thus, the power storage stacks can be more effectively disposed at high density.

Top wall portion 223 connects front wall portion 221 and rear wall portion 222 to each other. Top wall portion 223 has a concave-convex shape corresponding to the heights of front-side module 11 and electronic devices 71 and 72, center-side module 12, and electronic device 73 and rear-side module 13.

Specifically, top wall portion 223 includes a front portion 224, a center portion 225 and a rear portion 226. Front portion 224, center portion 225 and rear portion 226 are disposed in this order from the front side to the rear side.

Front portion 224 is disposed above front-side module 11 and electronic devices 71 and 72. A height position of front portion 224 is higher than that of center portion 225. A step portion 215a is formed between front portion 224 and center portion 225.

Center portion 225 is disposed above center-side module 12. Center portion 225 is located at a position lower than front portion 224 and rear portion 226.

Rear portion 226 has a first rear portion 227 and a second rear portion 228. First rear portion 227 is located above electronic device 73. A height position of first rear portion 227 is higher than that of center portion 225. A step portion 225b is formed between first rear portion 227 and center portion 225.

Second rear portion 228 is located on the rear side relative to first rear portion 227. Second rear portion 228 is located above second power storage module 15. A height position of second rear portion 228 is higher than that of first rear portion 227. A step portion 229 is formed between second rear portion 228 and first rear portion 227. The height position of second rear portion 228 is higher than that of front portion 224.

Step portion 225b, first rear portion 227 and step portion 229 described above, of top wall portion 223, function as a first wall portion facing second power storage module 15 from the front side.

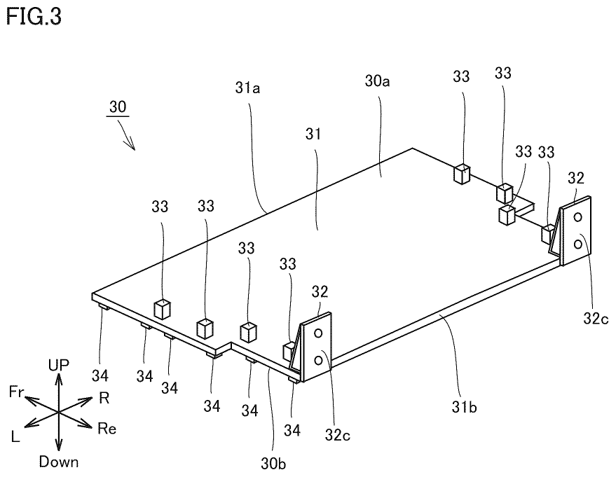

Support member 30 is disposed between first power storage module 14 and second power storage module 15 in the up-down direction. The lower side of second power storage module 15 is fixed to the upper surface 30a (see FIG. 3) side of support member 30. The upper side of first power storage module 14 is fixed to the lower surface 30b (see FIG. 3) side of support member 30. Support member 30 is fixed to accommodation case 20 as described below.

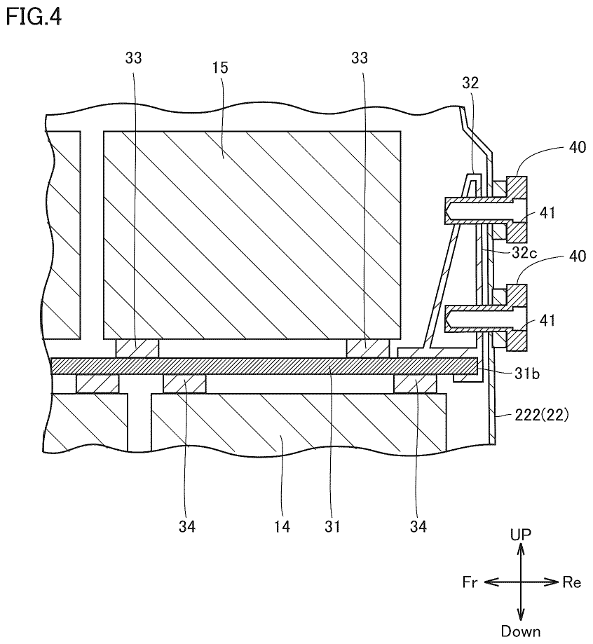

FIG. 3 is a perspective view of the support member according to the first embodiment. FIG. 4 is a cross-sectional view showing a state in which the support member is fixed to the accommodation case, according to the first embodiment. Details of support member 30 will be described with reference to FIGS. 3 and 4.

Support member 30 has a plate-like portion 31. Fixed portions 32 and a plurality of attachment portions 33 and 34 are provided on plate-like portion 31. An upper surface of plate-like portion 31 constitutes an upper surface 30a of support member 30, and a lower surface of plate-like portion 31 constitutes a lower surface 30b of support member 30.

Plate-like portion 31 has a first end portion 31a and a second end portion 31b. First end portion 31a is a front end of plate-like portion 31, and second end portion 31b is a rear end of plate-like portion 31.

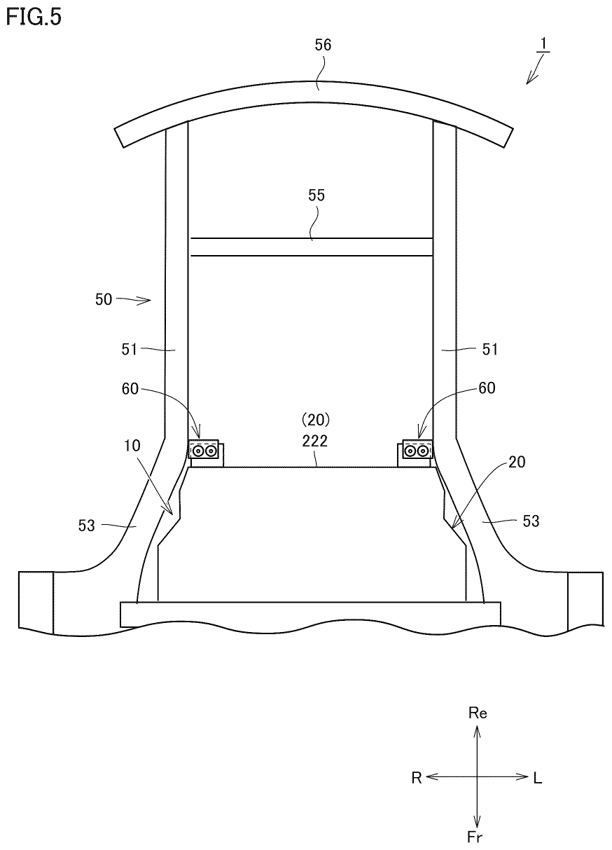

Fixed portions 32 are fixed to second end portion 31b. Two fixed portions 32 are provided. Two fixed portions 32 are provided on one side and on the other side in the width direction of the vehicle, respectively. It should be noted that the number of fixed portions 32 is not limited to two, and may be only one, or may be three or more. When two fixed portions 32 are provided, power storage device 10 can be efficiently fixed to a pair of rear-side members 51 (see FIG. 5) through fixed portions 32 and coupling members 60 (see FIG. 5) as described below.

Each of fixed portions 32 includes a portion 32c extending along rear wall portion 222. Portion 32c faces rear wall portion 222 and is fixed to rear wall portion 222 by a fastening member 40. An insertion portion 41 for fixing below-described coupling member 60 is provided in fastening member 40.

The plurality of module attachment portions 33 are provided on upper surface 30a of support member 30. The lower side of second power storage module 15 is fastened and fixed to the plurality of module attachment portions 33. The plurality of module attachment portions 34 are provided on lower surface 30b of support member 30. The upper side of first power storage module 14 is fastened and fixed to the plurality of module attachment portions 34.

As described above, in power storage device 10 according to the first embodiment, support member 30 to which first power storage module 14 and second power storage module 15 disposed in the up-down direction are fixed is fixed to accommodation case 20, whereby the rigidity of accommodation case 20 can be increased.

Furthermore, fixed portions 32 are fixed to upper case 22, whereby the rigidity of upper case 22 can be increased. When upper case 22 is made of a material having a rigidity lower than that of a metal material such as a resin material, the rigidity of upper case 22 can be increased more effectively.

FIG. 5 is a plan view showing a state in which the power storage device is fixed to a frame member of the vehicle, according to the first embodiment.

As shown in FIG. 5, vehicle 1 includes a vehicle frame member 50 and a plurality of coupling members 60. Vehicle frame member 50 includes, for example, a pair of side members and a plurality of cross members. The pair of side members include a pair of front-side members (not shown), a pair of rear-side members 51, and a pair of connection portions 53 that connect the pair of front-side members and the pair of rear-side members 51 to each other.

The pair of front-side members, the pair of connection portions 53 and the pair of rear-side members 51 extend along the front-rear direction of vehicle 1 and are located in this order from the front side to the rear side of vehicle 1. The pair of front-side members, the pair of connection portions 53 and the pair of rear-side members 51 are spaced apart from each other in the width direction of vehicle 1.

A rear end panel 56 is provided on the rear end side of the pair of rear-side members 51. Rear end panel 56 constitutes a rear portion of vehicle 1. A cross member 55 is disposed on the front side of rear end panel 56. Cross member 55 is provided to connect the pair of rear-side members 51 to each other, and extends along the width direction of vehicle 1. Cross member 55 is disposed on the rear side of power storage device 10.

Rear wall portion 222 of accommodation case 20 is located between the pair of rear-side members 51 or between the above-described pair of connection portions 53.

Accommodation case 20 is coupled to vehicle frame member 50 by the plurality of coupling members 60. Specifically, accommodation case 20 is fixed and coupled to the pair of rear-side members 51 by two coupling members 60. More particularly, accommodation case 20 is fixed to rear-side member 51 located on one side in the width direction by coupling member 60 disposed on one side in the above-described width direction, and is fixed to rear-side member 51 located on the other side in the width direction by coupling member 60 disposed on the other side in the above-described width direction.

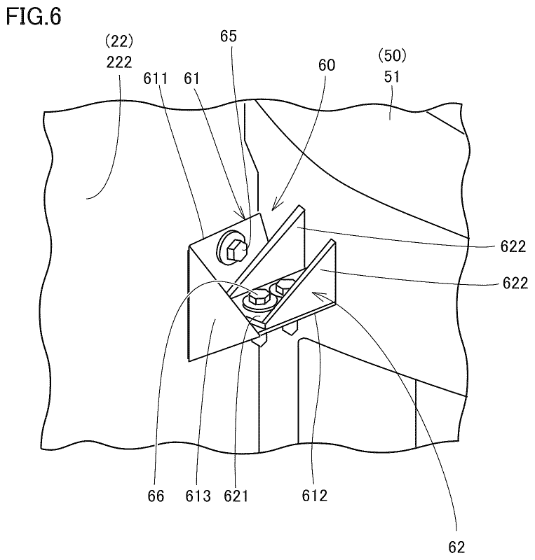

FIG. 6 is an enlarged perspective view showing a state in which the power storage device is fixed to the frame member by the coupling member, according to the first embodiment.

As shown in FIG. 6, coupling member 60 includes a first member 61, a second member 62, a first fastening member 65, and a second fastening member 66.

First member 61 includes a first portion 611, a second portion 612 and a reinforcing portion 613. First portion 611 is provided along rear wall portion 222 of accommodation case 20. First portion 611 has a plate shape and abuts on rear wall portion 222. Second portion 612 is provided to intersect first portion 611. Second portion 612 protrudes rearward from first portion 611. Second portion 612 has a plate shape. Reinforcing portion 613 connects first portion 611 and second portion 612 to each other. Specifically, reinforcing portion 613 connects ends portions of first portion 611 and second portion 612 to each other on a side opposite to a side where closest rear-side member 51 is located.

First member 61 is fixed to accommodation case 20 by first fastening member 65. Specifically, first fastening member 65 is inserted into above-described insertion portion 41 through first portion 611, whereby first member 61 is fixed to rear wall portion 222 and fixed portion 32. That is, first member 61 is fixed to a portion where support member 30 is fixed to accommodation case 20.

Second member 62 includes a first piece portion 621 and second piece portions 622. First piece portion 621 has a plate shape, for example. First piece portion 621 is disposed on first portion 611 and is fixed to first portion 611 by second fastening member 66. An end portion of first piece portion 621 on the side where closest rear-side member 51 is located is fixed to a side surface of this rear-side member 51 by welding or the like.

Second piece portions 622 are provided to protrude in the up-down direction from both end portions of first piece portion 621 located in the front-rear direction. Each of second piece portions 622 has a shape extending upward toward closest rear-side member 51. The end portion of second piece portion 622 on the side where closest rear-side member 51 is located is fixed to the side surface of this rear-side member 51 by welding or the like.

As described above, second member 62 fixed to rear-side member 51 is fixed to first member 61 in a state where first member 61 is fixed to accommodation case 20, whereby accommodation case 20 and vehicle frame member 50 are coupled to each other by coupling member 60.

At this time, first member 61 is fixed to the portion where support member 30 is fixed to accommodation case 20 as described above, whereby the rigidity of accommodation case 20 and the rigidity of vehicle frame member 50 can be effectively increased.

### Second Embodiment

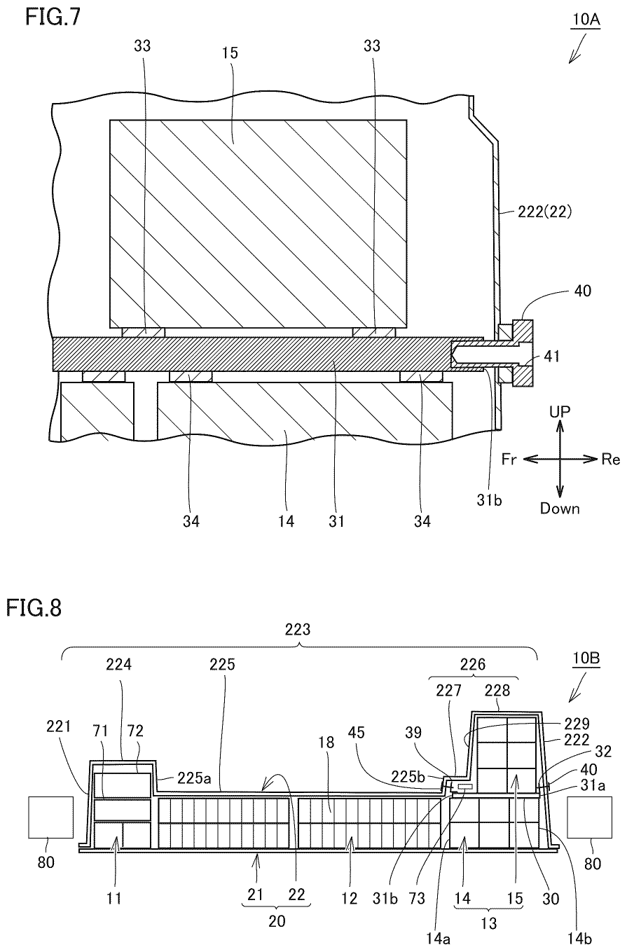

FIG. 7 is a cross-sectional view showing a state in which a support member is fixed to an accommodation case, according to a second embodiment. A power storage device 10A according to the second embodiment will be described with reference to FIG. 7.

As shown in FIG. 7, power storage device 10A according to the second embodiment is different from power storage device 10 according to the first embodiment in that fixed portions 32 are not provided and support member 30 is directly fixed to accommodation case 20. Specifically, second end portion 31b of plate-like portion 31 is fixed to rear wall portion 222 of upper case 22 by fastening member 40.

Even when power storage device 10A according to the second embodiment is configured as described above, power storage device 10A according to the second embodiment achieves substantially the same effect as that of power storage device 10 according to the first embodiment.

### Third Embodiment

FIG. 8 is a schematic view of a power storage device according to a third embodiment. A power storage device 10B according to the third embodiment will be described with reference to FIG. 8.

As shown in FIG. 8, power storage device 10B according to the third embodiment is different from power storage device 10 according to the first embodiment in terms of a state of fixation of support member 30. Power storage device 10B according to the third embodiment is otherwise substantially the same as power storage device 10 according to the first embodiment.

In power storage device 10B according to the third embodiment, support member 30 is fixed to the first wall portion constituted by step portion 225b, first rear portion 227 and step portion 229, and rear wall portion 222 serving as the second wall portion.

Specifically, a fixed portion 39 (second fixed portion) is provided on the first end portion 31a side and fixed portion 39 is fixed to the above-described first wall portion. In addition, similarly to the first embodiment, fixed portion 32 (first fixed portion) provided on the second end portion 31b side is fixed to rear wall portion 222.

Even when power storage device 10B according to the third embodiment is configured as described above, power storage device 10B according to the third embodiment achieves substantially the same effect as that of power storage device 10 according to the first embodiment. In addition, as described above, support member 30 is fixed to the first wall portion and the second wall portion of upper case 22 at two locations on the front side and on the rear side, and thus, the rigidity of upper case 22 can be further increased. First end portion 31a may be directly fixed to the first wall portion.

Although the embodiments of the present disclosure have been described, it should be understood that the embodiments disclosed herein are illustrative and non-restrictive in every respect. The scope of the present disclosure is defined by the terms of the claims, and is intended to include any modifications within the scope and meaning equivalent to the terms of the claims.

What is claimed is:

1. A power storage device comprising:
a first power storage module;
a second power storage module disposed above the first power storage module;
an accommodation case that accommodates the first power storage module and the second power storage module; and
a support member disposed between the first power storage module and the second power storage module in an up-down direction, wherein
a lower side of the second power storage module is fixed to an upper surface side of the support member,
an upper side of the first power storage module is fixed to a lower surface side of the support member, and
the support member is fixed to the accommodation case.

2. The power storage device according to claim 1, wherein
the support member includes a fixed portion fixed to the accommodation case,
the accommodation case includes an upper case, and
the fixed portion is fixed to the upper case.

3. The power storage device according to claim 2, wherein
in a front-rear direction orthogonal to the up-down direction, the upper case includes a first wall portion facing the second power storage module from a front side, and a second wall portion facing the second power storage module from a rear side, and
the support member is fixed to each of the first wall portion and the second wall portion.

4. The power storage device according to claim 1, wherein
each of the first power storage module and the second power storage module includes a front end portion and a rear end portion in a front-rear direction orthogonal to the up-down direction, and
the rear end portion of the second power storage module is located on a front side relative to the rear end portion of the first power storage module.

5. A vehicle comprising:
the power storage device as recited in claim 1;
a vehicle frame member; and
a coupling member that couples the accommodation case and the vehicle frame member to each other, wherein
the coupling member is fixed to a portion where the support member is fixed to the accommodation case.
